(19) United States
(12) Patent Application Publication
(10) Pub. No.: US 2013/0344202 A1
(43) Pub. Date: Dec. 26, 2013

(54) Healthful Sea Salt Mixture

(71) Applicant: Nancy Alisa Gibbons Addison, Dallas, TX (US)

(72) Inventor: Nancy Alisa Gibbons Addison, Dallas, TX (US)

(21) Appl. No.: 13/531,343

(22) Filed: Jun. 22, 2012

(51) Int. Cl. A23L 1/237; A23L 1/302; A23L 1/303

(52) U.S. Cl. 426/73; 426/649; 426/72

(57) ABSTRACT

A healthful sea salt mixture composed of at least one whole sea salt, at least one organic whole sea vegetable, at least one whole raw sesame seed type, optional chia seeds and optional milk thistle. The at least one whole sea salt includes but is not limited to Celtic sea salt, pink Himalayan sea salt, and Bolivian rose sea salt. The at least one organic whole sea vegetable includes but is not limited to alaria, dulse, kelp, layer, and sea lettuce. The at least one whole raw sesame seed type includes various families of sesame seeds. The present invention provides a whole food source that has numerous minerals and nutrients. The present invention also serves as an iodine supplement for those with a thyroid-related condition. Furthermore, the present invention provides vitamin E, which aids in iodine absorption. The range of nutrients provided includes potassium, calcium, sodium, vitamins, and others.

### FIELD OF THE INVENTION

The present invention relates generally to a nutritional sea salt mixture which provides essential minerals and nutrients such as iodine, sodium, potassium, iron, vitamins, protein, and fiber.

### BACKGROUND OF THE INVENTION

Numerous chronic diseases such as heart disease, chronic bronchitis, asthma bone deformities, thyroid disease, and others have been on the rise as a result of depletion of minerals in the foods. These minerals include iodine, magnesium, iron, potassium, calcium, magnesium, zinc, and others (USDA, 1997). Thyroid related diseases are increasing worldwide. Today, millions of people are afflicted with a thyroid related condition. One of the main causes of a thyroid disease is iodine deficiency (“American thyroid association,” 2012). Iodine is an element required to produce thyroid hormones, which are important for growth, development, and brain functions. Inadequate uptake of iodine leads to health problems such as mental retardation, cretinism, goiter, miscarriage, stillbirth, and many others. Obtaining sufficient amounts of iodine is important for women who are pregnant or breastfeeding, women who may become pregnant and young children (“Public health and,” 2012). The present invention is designed to supplement numerous minerals including the rare mineral, iodine, in one's diet in an optimally, healthy, whole food form. Furthermore, the present invention can be used to correct iodine deficiency in vulnerable populations such as those affected by nuclear reactor accidents (Katz, 2011).

Mineral deficiency, including iodine deficiency, results when soil is poor in minerals, including iodine. Poor soil causes mineral deficiency in food products as well as low iodine intake in the population. When the body does not intake adequate amounts of minerals, chronic diseases can be resulted. Iodine is one of these missing minerals. When the body does not take in adequate amounts of iodine, the thyroid may no longer be able to synthesize sufficient amounts of thyroid hormone. The resulting low-level of thyroid hormone in the blood is the main factor responsible for a series of functional and developmental abnormalities, collectively referred to as iodine deficiency disorders. The present invention incorporates not only unrefined sea salts but also sea vegetables, both of which are sources of natural iodine, iodine-127. The present invention further comprises nutritious minerals such as potassium, calcium, sodium, magnesium, phosphorus, iron, manganese, copper, chromium, zinc, vitamin A, vitamin B1, vitamin B2, vitamin B3, vitamin B6, vitamin B12, vitamin C, vitamin E, and others. The aforementioned minerals are vital in preventing many diseases. Incorporating the aforementioned minerals into the diet in a healthy whole food way can help supplement a person's body with needed minerals required to help avoid many chronic diseases, one of which is thyroid disease (USDC, 1996, Werbach, 1993). The nutritious benefits of each mineral will be specified in the Detailed Description Of The Invention.

Today, the average consumer does not obtain sufficient essential nutrients due to the prevalence of highly processed and genetically modified foods as well as normal whole foods not having the same nutrient density as they did a few decades ago. Normal whole foods as well as genetically engineered and highly processed foods no longer contain the essential nutrients and minerals found in natural food sources such as unrefined sea salt and sea vegetables. According to the United States Department of Agriculture (USDA), foods on the market today are simply less nutrient dense than they have been in the past. Therefore, nutrient deficiency is possible for people who consume sufficient amounts of whole unprocessed foods as well. Unrefined sea salt contains many important minerals including iodine, calcium, iron, magnesium, iodine, potassium, sodium, as well as many other minerals needed in today's healthful diet. Iodine is especially important in maintaining the proper functioning of the thyroid, which is a master gland. As a master gland, the thyroid controls all the vital functions within the body. These vital functions include metabolism, digestion, body temperature, mental acuity and hormone regulations. Unfortunately, common table salt has prevalently replaced natural, unrefined sea salt. Moreover, common table is not a reliable source of iodine due to the natural tendency of iodine to dissipate in the presence of oxygen. Furthermore, common table salt is a white, refined, processed salt which is 98 percent of sodium chloride with added chemicals such as bicarbonates, sugar, and preservatives (Leo, 2010). Due to refining processes, the common table salt has been stripped of natural minerals which are commonly found in natural, unrefined sea salt. The present invention comprises natural, unrefined sea salt, some of the choices that can be used originate in old oceans that are rich in nutrients and not contaminated with pollutions from the today's environment.

Iodine is not very abundant in the Earth's crust. The abundance of iodine is estimated to be about 0.3-0.5 parts per million, placing it in the bottom third of the elements in terms of abundance. Iodine never occurs as a free element, but usually as sodium iodide (NaI) or potassium iodide (KI). These compounds were present in the ancient oceans and were deposited in massive salt beds when those oceans dried up. They were buried underground a long time ago by the earth movements. They currently exist in the form of salt domes. Sodium iodide and potassium iodide mined from these salt domes are the primary sources of the element today. Compounds of iodine are also present in sea water and sea vegetables. White refined table salt has had the whole sea salt stripped of minerals leaving sodium chloride. Table salt is sodium chloride combined with iodine sources, stabilizers for iodine, and anti-caking compounds to prevent salt grains from absorbing water from the air. Potassium iodide is added to prevent mental retardation associated with iodine deficiency. A project started by the Michigan State Medical Society in 1924 promoted the addition of iodine to table salt, and by the mid 1950s, three quarters of U.S. households used only iodized salt. Potassium iodide makes up 0.06 percent to 0.01 percent of table salt by weight. Sometimes cuprous iodide (iodide of copper) is used as the source of iodine (Batmanghelidj, 1997).

Glucose or dextrose is a sugar or high fructose corn syrup, which is added in small amounts (0.04 percent) to white refined table salt. White refined sugar, high fructose corn syrup, and fructose are very taxing on the digestive system and the body. These sugars are read by the body as empty sugar. When the body consumes nutrient-empty sugar, the body has to pull stored nutrients out of the body in order to process the nutrient empty sugar. This depletes the body of stored nutrients and can result in extreme cravings for nutrients by the body (Addison, 2012). Other chemical additives to white refined table salt are: calcium silicate, ferric ammonium citrate, silicon dioxide, sodium ferrocyanide, magnesium silicate, magnesium carbonate, propylene glycol, aluminum calcium silicate, sodium aluminosilicate or sodium silicoaluminate, and calcium phosphate (Batmanghelidj, 1997).

Calcium silicate is an anti-caking additive added to salt. Since salt is hygroscopic, calcium silicate absorbs moisture from air to prevent the salt from caking. Less than 0.5 percent is generally used, so the salt may still become lumpy in very humid weather. Other anti-caking ingredients include ferric ammonium citrate, silicon dioxide, sodium ferrocyanide, magnesium silicate, magnesium carbonate, propylene glycol, aluminum calcium silicate, sodium aluminosilicate or sodium silicoaluminate, and calcium phosphate (Batmanghelidj, 1997).

### BRIEF DESCRIPTION OF THE DRAWINGS

FIG. 1 is a view of the healthful sea salt composition.

FIG. 2 is a view of the preferred embodiment of the healthful sea salt composition.

### DETAILED DESCRIPTION OF THE INVENTION

All illustrations of the drawings are for the purpose of describing selected versions of the present invention and are not intended to limit the scope of the present invention.

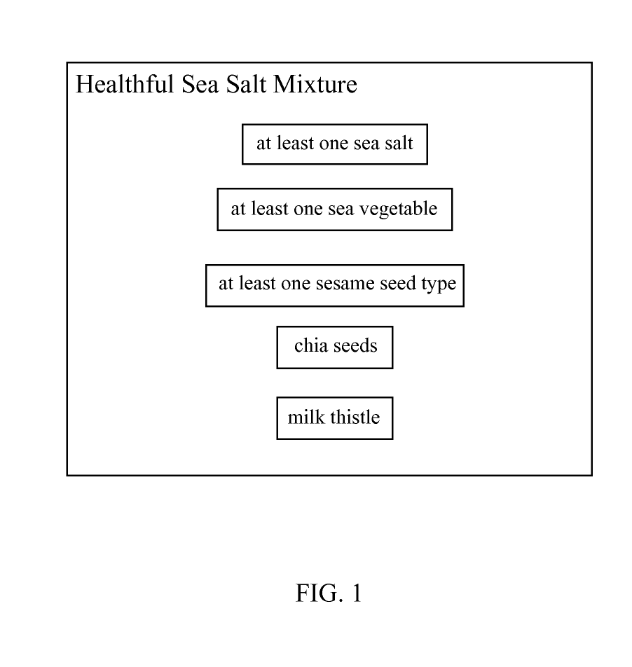

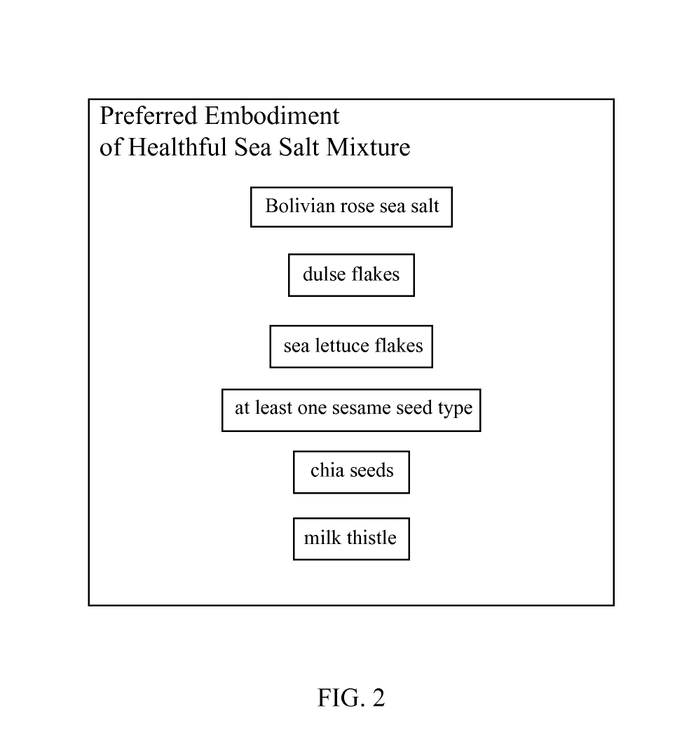

The present invention is a healthful sea salt mixture composed of an at least one whole sea salt, an at least one organic whole sea vegetable, an at least one whole, raw sesame seed type, optional chia seeds and optional milk thistle. The composition of the healthful sea salt mixture is illustrated in FIG. 1. The at least one whole sea salt comprises compounds selected from the group consisting of Bolivian sea salt, Celtic sea salt, pink Himalayan sea salt and other types of sea salt. The at least one organic whole sea vegetable comprises compounds selected from the group consisting of alaria or alaria esculenta, dulse or palmaria palmata, kelp or laminaria longicruris, laver or porphyra umbilicalis, sea lettuce or ulva lactuca. The at least one whole raw sesame seed type comprises compounds selected from the group consisting of various families of sesame seeds. The preferred embodiment of the healthful sea salt mixture is illustrated in FIG. 2. The healthful sea salt mixture provides a rich, whole food source composed of important nutrients and minerals such as iodine, iron, magnesium, potassium, calcium, vitamins, fiber, protein, and so forth. In addition to serving as a rich whole food source, the healthful sea salt mixture also serves as a substantial iodine supplement. Furthermore, the incorporation of the at least one whole raw sesame seed type provides vitamin E, which helps the body absorb iodine in the at least one organic whole sea vegetable (Addison, 2012). The rich mineral profile and percentage composition of each component of the present invention are all illustrated in the tables herein. Furthermore, the important health benefits of each important mineral and nutrient will be disclosed hereinbelow.

TABLE 1
Nutrition Facts Of Bolivian Rose Sea Salt
Nutrition Facts

| Serv. Size: | ¼ tsp | Amount/Serving | | | % DV* | Amount/Serving | | % DV* |
|---|---|---|---|---|---|---|---|---|
| Serv. Approx | 1.076 g | Total Fat | 0 | g | 0% | Total Carb | 0 g | 0% |
| | | Sat. Fat | 0 | g | 0% | Total Carb. | 0 g | 0% |
| Calories 0 g | | Trans Fat | 0 | g | | | | |
| Fat Cal. 0 g | | Cholesterol | 0 | g | 0% | Sugars | — | |
| | | Sodium | 416 | mg | 17% | Protein | 0 g | |

| | | | | | |
|---|---|---|---|---|---|
| Vitamin A | 0% | Vitamin C 0% | Calcium | 0% | Iron 0% |

*Percent Daily Value (DV) are based on a 2000 calorie diet

TABLE 2
Mineral Composition Of Bolivian Rose Sea Salt
Chemical Specification

| Nutrient | % | Trace Metals | PPM |
|---|---|---|---|
| Sodium Chloride | 95.500 | All trace metals | <5 ppm |
| (NaCl) | | | |
| Calcium (Ca) | 0.700 | | |
| Potassium (K) | 0.645 | | |
| Iron (Fe) | 0.303 | | |
| Magnesium (Mg) | 0.208 | | |
| Iodine (I) | <0.003 | | |

TABLE 3
Grain Sizes Of Bolivian Rose Sea Salt
Granulmetry

| | Low | High |
|---|---|---|
| Grain | Average | Average |
| A (Fine) | 0.3 mm | 1 mm |
| B | 1 mm | 2 mm |
| C (Coarse) | 2 mm | 3 mm |
| D | 3 mm | 4 mm |
| E | 4 mm | 5 mm |

TABLE 4
Nutrition Facts Of Pink Himalayan Sea Salt
Nutrition Facts

| | | Amount/ | | Amount/ | |
|---|---|---|---|---|---|
| | | Serving | % DV* | Serving | % DV* |
| Serv. Size: | ¼ tsp | | | | |
| Serv. Approx | 1.076 g | Total Fat 0 g | 0% | Total Carb. | 0% |
| | | | | 0 g | |
| | | Sat. Fat 0 g | 0% | Total Carb. | 0% |
| | | | | 0 g | |
| Calories 0 g | | Trans Fat 0 g | | | |
| Fat Cal. 0 g | | Cholest 0 g | 0% | Sugars -- | |
| *Percent Daily | | Sodium | 17% | Protein 0 g | |
| Value (DV) | | 416 mg | | | |
| are based on a | | Vitamin A | Vitamin | Calcium 0% | Iron |
| 2000 calorie | | 0% | C 0% | | 0% |
| diet | | | | | |

TABLE 5
Mineral Composition Of Pink Himalayan Sea Salt
Chemical Specification

| Nutrient | % | Trace Metals | PPM |
|---|---|---|---|
| Chloride (Cl) | 60.050 | Nickel (Ni) | <1.080 |
| Sodium (Na) | 39.000 | Lead (Pb) | <0.250 |
| Sulfur (S) | 0.346 | Chromium | <0.215 |
| | | (Cr) | |
| Calcium (Ca) | 0.210 | Copper (Cu) | <0.215 |
| Magnesium (Mg) | 0.150 | Zinc (Zn) | <0.215 |
| Potassium (K) | 0.100 | | |
| Iodine (I) | <0.003 | | |

TABLE 6
Grain Sizes Of Pink Himalayan Sea Salt
Granulmetry

| | | High |
|---|---|---|
| Grain | Low Average | Average |
| Powder | 0 mm | 0.2 mm |
| X-Fine | 0 mm | 0.5 mm |
| Fine | 0 mm | 1 mm |
| Small | 1 mm | 2 mm |
| Medium | 2 mm | 3 mm |
| Coarse | 3 mm | 4 mm |
| X-Coarse | 4 mm | 6 mm |

TABLE 7
Nutrition Facts Of Sea Vegetables from Maine Coast Sea Vegetables
Nutritional Analysis of Maine Coast Sea Vegetables
based on 7 g whole leaf sea vegetables

| | | | | | Sea | | |
|---|---|---|---|---|---|---|---|
| | Alaria | Dulse | Kelp | Laver | Lettuce | Daily | |
| | Alaria | Palmaria | Laminaria | Porphyra | Ulva | Value | |
| | esculenta | palmata | longicruris | umbilicalis | lactuca | (RDI) | |
| Protein g | 1 | 2 | 1 | 2 | 1 | 50 | g |
| Fat g | 0 | 0 | 0 | 0 | 0 | 65 | g |
| Carbohydrates g | 3 | 3 | 3 | 3 | 3 | 300 | g |
| Calories cal | 18 | 18 | 17 | 22 | 19 | 2000 | cal |
| Fiber g | 3 | 2 | 2 | 2 | 2 | 25 | g |
| Calcium mg | 77 | 15 | 66 | 13 | 0 | 1000 | mg |
| Potassium mg | 535 | 547 | 784 | 188 | 196 | 3500 | mg |
| Magnesium mg | 64 | 19 | 63 | 26 | 105 | 400 | mg |
| Phosphorous mg | 35 | 29 | 30 | 29 | Not | 1000 | mg |
| | | | | | Tested | | |
| Iron mg | 1 | 2 | 3 | 1 | 1 | 18 | mg |
| Sodium mg | 297 | 122 | 312 | 113 | 224 | 2400 | mg |
| Iodine μg | 1162 | 1169 | 3170 | 98 | 27 | 150 | μg |
| Manganese mg | 0.07 | 0.08 | 0.09 | 0.24 | 0.28 | 2.0 | mg |
| Copper mg | 0.01 | 0.03 | 0.01 | 0.04 | 0.13 | 2.0 | mg |
| Chromium μg | 10 | 10 | 20 | 10 | 9 | 120 | μg |
| Zinc mg | 0.24 | 0.2 | 0.2 | 0.29 | 0.15 | 15 | mg |
| Vitamin A IU | 594 | 46 | 39 | 300 | Not | 5000 | IU |
| | | | | | Tested | | |
| Vitamin B1 mg | 0.04 | 0.01 | 0.04 | 0.04 | 0.01 | 1.5 | mg |
| Vitamin B2 mg | 0.19 | 0.13 | 0.17 | 0.21 | 0.05 | 1.7 | mg |
| Vitamin B3 mg | 0.74 | 0.13 | 0.25 | 0.41 | 0.19 | 20 | mg |
| Vitamin B6 mg | 0.44 | 0.63 | 0.6 | 0.78 | Not | 2.0 | mg |
| | | | | | Tested | | |
| Vitamin B12 μg | 0.35 | 0.46 | 0.18 | 1.23 | Not | 6.0 | μg |
| | | | | | Tested | | |
| Vitamin C mg | 0.41 | 0.44 | 0.29 | 0.84 | Not | 60 | mg |
| | | | | | Tested | | |
| Vitamin E IU | 0.34 | 0.12 | 0.19 | 0.36 | Not | 30 | IU |
| | | | | | Tested | | |

TABLE 8
Nutrition Facts Of Sea Seasonings From Maine Coast Sea Vegetables
Sea Seasonings Nutritional Chart

| | | Dulse | | Kelp | Sea | Triple |
|---|---|---|---|---|---|---|
| | Dulse | Granules | Kelp | Granules | Salt | Blend |
| | Granules | w/Garlic | Granules | w/Cayenne | w/Sea Veg | Flakes |
| | Palmaria | Palamria | Laminaria | Laminarie | L. digitata | P. umbilicalis, |
| | Palmata | Palmata | digitata | digitata | & P. palmata | Palamsta Ulva |
| Serving Size | 1 tsp. | 1 tsp. | ¼ tsp. | ¼ tsp. | ¼ tsp. | 1 tsp. |
| Grams | 2 | 2 | 0.75 | 0.75 | 1.5 | 2 |
| Calories | 5 | 4 | 2 | 2 | 0 | 10 |
| Carbohydrates g | <1 | <1 | <1 | <1 | <1 | <1 |
| Total Fat | 0 | 0 | 0 | 0 | 0 | 0 |
| Protein | 0 | 0 | 0 | 0 | 0 | 0 |
| Cholesterol | 0 | 0 | 0 | 0 | 0 | 0 |
| Calcium mg | 10 | 9 | 10 | 10 | 3 | 5 |
| Iodine μg | 330 | 250 | 3390 | 3220 | 370 | 239 |
| Iron mg | 1 | 1 | 0 | 0 | 0 | 4 |
| Magnesium mg | 6 | 6 | 5 | 5 | 19 | 7 |
| Potassium mg | 131 | 125 | 60 | 60 | 19 | 90 |
| Sodium mg | 35 | 35 | 25 | 20 | 400 | 30 |
| Vitamin A IU | 13 | 13 | 0 | 0 | 0 | 17 |

TABLE 9
Nutrition Facts For Seaweed Support Formulas From Maine Coast Sea
Vegetables
Nutritional Information For Seaweed Support Formulas
based on two vegetable capsules per serving (770 mg)

| | Original Formula | Iodine Formula | |
|---|---|---|---|
| | Amount | Amount | US RDA |
| Protein g | 0.12 | 0.16 | 50 |
| Carbohydrate g | 0.34 | 0.32 | 300 |
| Calories | 1.92 | 1.98 | 2000 |
| Fiber g | 0.25 | 0.25 | 25 |
| Calcium mg | 2.29 | 2.68 | 1000 |
| Potassium mg | 60 | 46 | 3500 |
| Magnesium mg | 2.2 | 5.2 | 400 |
| Phosphorus mg | 3.1 | 2.6 | 1000 |
| Iron mg | 0.64 | 4 | 18 |
| Sodium mg | 15 | 15 | 2400 |
| Iodine μg | 104 | 225 | 150 |
| Manganese mg | 0.01 | 0.03 | 2.00 |
| Copper mg | 0.003 | 0.001 | 2.0 |
| Chromium μg | 1.34 | 1.34 | 120 |
| Zinc mg | 0.02 | 0.02 | 15 |

TABLE 10
Nutrition Facts Of Chia Seeds

| Nutrition Facts Of Chia Seeds | | | |
|---|---|---|---|
| Serving Size28 g (~1 oz.) | | | |
| (Approx. 16.2 | | | |
| Servings/Pound) | | | |
| Amount Per Serving | | | |
| Calories | 137 | | |
| Calories From Fat | 72 | | |
| | | | % DV |
| Total Fat | 9 | g | 13% |
| Saturated Fat | 1 | g | 4% |
| Cholesterol | 0 | mg | 0% |
| Sodium | 5 | mg | 0% |
| Total Carbohydrate | 12 | g | 4% |
| Dietary Fiber | 11 | g | 42% |
| Sugars | 0 | g | |
| Protein | 4 | g | |

| | |
|---|---|
| Vitamin A 0% | Calcium 18% |
| Vitamin C 0% | Iron 0% |

TABLE 11
Nutrition Facts Of Sesame Seeds

| Nutrition Facts | | |
|---|---|---|
| Serving Size 40 g (~1.4 oz.) | Amount Per | |
| (Approx. 11.4 | Serving | |
| Servings/Pound) | | |
| Calories | 250 | |
| Calories From Fat | 180 | |
| | | % DV |

| | | | |
|---|---|---|---|
| Total Fat | 20 | g | 30% |
| Saturated Fat | 3 | g | 15% |
| Sodium | 5 | mg | 0% |
| Total Carbohydrate | 8 | g | 3% |
| Dietary Fiber | 5 | g | 21% |
| Protein | 9 | g | |

| | | | |
|---|---|---|---|
| Vitamin A | ** | Calcium | 2% |
| Vitamin C | ** | Iron | 70% |

As illustrated from Table 1 to Table 11, the minerals and nutrients present in the at least one whole sea salt, the at least one organic whole sea vegetable, the at least one whole raw sesame seed type, chia seeds are numerously diverse. According to Table 1 and Table 4, the daily value percentage of sodium in both Bolivian rose sea salt and pink Himalayan sea salt is only 17 percent, which is desirably low. A low amount of sodium in diet is desirable since the mineral has been frequently linked to high blood pressure or hypertension (Doheny, 2011). Table 2 and Table 5 both illustrate the mineral composition of both the Bolivian rose sea salt and the pink Himalayan sea salt, respectively. The mineral compositions illustrate the diverse minerals harbored within these natural, unrefined sea salts. These minerals include sodium chloride, calcium, potassium, iron, magnesium, iodine, nickel, lead, chromium, copper, and zinc. Table 3 and Table 6 of the present invention illustrate the relatively large grain sizes of the Bolivian rose sea salt and the pink Himalayan sea salt. The large grain sizes of both the pink Himalayan sea salt and Bolivian rose sea salt indicate large crystalline structures for various minerals to be entrapped therewithin.

In the preferred embodiment, the at least one organic whole sea vegetable has been obtained from Maine Coast Sea Vegetables as illustrated from Table 7 to Table 9. From Table 7 to Table 9, it is clearly illustrated the diverse mineral and nutrient composition of each sea vegetables. All sea vegetables illustrated comprise protein, carbohydrates, calories, fiber, calcium, magnesium, phosphorous, iron, sodium, iodine, manganese, copper, chromium, zinc, vitamin A, vitamin B1, vitamin B2, vitamin B3, vitamin B6, vitamin B12, vitamin C, vitamin E. These sea vegetables further comprise omega-3, omega-6, and essential amino acids.

The present invention optionally incorporates chia seeds whose nutrition facts are illustrated in Table 10. Furthermore, the chia seeds utilized in the present invention are whole organic chia seeds. According to Table 10, chia seeds are high in dietary fiber and calcium, which are both nutritious to the body. Moreover, chia seeds are high in omega-3 (Addison, 2012). The benefits of omega-3 include improving artery health by reducing plaque buildup and blood clots in arteries that lead to the brain, improving cholesterol by lowering triglycerides and elevating high density lipoprotein (HDL), improving joint health by reducing joint tenderness and stiffness associated with arthritis and osteoarthritis, improving bone health by positively impacting calcium levels of the body and allowing nerve cells to better communicate with one another, improving skin health by alleviating symptoms related to skin disorders like acne and psoriasis, improving bowel health by reducing inflammation of the bowels, helping alleviating symptoms of Crohn's disease and ulcerative colitis, improving lung health by reducing inflammation in diseases like asthma (Barnes, 2012). A deficiency in omega-3 may appear as inflammation, water retention, and high blood pressure. Chia seeds contain more omega-3 fatty acids than Atlantic salmon, but unlike the salmon, chia seeds also are about 10 percent omega-6 oil. Therefore, chia seeds are a more perfect balance of omega fats. Chia seeds are three omega-3s to one omega-6. Along with rich omega oils, chia seeds also have four times more calcium than milk. One ounce of chia seeds comprises 179 mg of calcium whereas one ounce of whole milk comprises 36 mg of calcium. Moreover, chia seeds contain more anti-oxidants than fresh blueberries, and more protein, calcium, and fiber than flax seeds (Addison, 2012).

The healthful sea salt mixture comprises the at least one whole raw sesame seed type whose nutrition facts are shown in Table 11. Furthermore, the at least one whole raw sesame seed type utilized in the preferred embodiment are whole, certified organic, raw, unhulled sesame seeds. Half a cup of sesame seeds contains three times more calcium than half a cup of whole milk. In addition to being a reliable dietary source of calcium, sesame seeds are also a dependable source of minerals such as manganese, copper, magnesium, iron, phosphorus, vitamin B1 or thiamin, zinc, vitamin E, healthy protein, and fiber (Kim, 2008). As illustrated in Table 11, sesame seeds contain 70 percent daily value of iron and 21 percent daily value of dietary fiber. Sesame seeds also contain sesamin and sesamolin, two substances that are thought to prevent high blood pressure and protect the liver against oxidative damage (Kim, 2008). Moreover, vitamin E in the at least one whole raw sesame seed type helps the body absorb iodine in the kelps or sea vegetables. If the body is low in vitamin E, the thyroid gland will not be able to absorb iodine effectively. Therefore, the present invention does not only provide iodine, but the present invention also provides vitamin E, which helps the body absorb the iodine more readily (Addison, 2012).

The present invention optionally comprises milk thistle, which is an herbal remedy associated with liver health. The usage of the plant as an herbal remedy has been dated back to the Greco-Roman era. The plant, commonly found in the United States, comprises red and purple flowers and brown, spotted fruit Milk thistle has been traditionally used by herbalists and physicians to combat early liver damage. The plant helps preserve the function of the liver to protect against the formation of cirrhosis or scarring of liver tissue. Furthermore, the plant helps sustain the ability of the liver to regenerate itself. Silymarin has been thought to be the primary active ingredient in milk thistle. The most effective dosage for liver protection is 420 mg of silymarin daily. A reliable milk thistle product should always disclose the percentage composition of silymarin in each dose. Typically, the amount of silymarin in each dose found in the market is 80 percent. The conscious consumer should make a calculated choice in determining the proper dosage. For example, if a product contains 175 mg of 80 percent silymarin per tablet, each tablet contains 140 mg of silymarin and four tablets should be taken each day (“Benefits of milk,” 2012).

Many studies have shown the benefit in prescribing milk thistle to those inflicted with liver disease. Typically, these individuals sustained liver damage from alcohol abuse. In these studies, the ability of milk thistle to normalize elevated blood tests was examined. Other studies, however, have shown no great improvement in the overall health of the liver when linked to other specific causes such as the viral infection hepatitis C or preexisting damage like established cirrhosis. Cancer research is now exploring the potential benefits of milk thistle. Most of the research to date has focused on skin tumor treatment or prevention in animals, with milk thistle demonstrating a positive impact. It is not clear, however, what types of cancer can be most impacted by this herbal method. Though not available in the United States, milk thistle has long been used intravenously in Europe to treat mushroom poisoning. Milk thistle appears to be very safe, with tests showing no significant drug interactions and relatively high tolerance levels. Mild stomach upset is the only documented side effect. Milk thistle is part of the aster plant family, which includes thistles, artichokes and daisies. It is recommended that a person with allergies specific to this group should avoid this supplement. As members in the medical community await for further research, milk thistle is deemed to be a safe herbal remedy for liver-related ailments, especially for individuals who have used or are using liver-toxic substances such as alcohol or medications Milk thistle is incorporated into diet in an attempt to protect the liver from potential damage of medications like acetaminophen, cholesterol-lowering statin drugs and seizure medicine such as phenytoin (“Benefits of milk,” 2012).

The present invention comprises raw, unprocessed whole food, which is a good source of live enzymes. Live enzymes regenerate cells and feed the body. The more living whole food consumed, the more the body can cleanse itself of toxins that are accumulated throughout the day. Whole food that has not been heated or processed higher than 105 to 118 degrees is living food. Heating and processing food destroys the live enzymes within. As a person ages, he or she loses the ability to produce sufficient digestive enzymes. Consuming certain foods such as meats, not properly chewing the food, and chewing gum make the body utilize more of the digestive enzymes than necessary. These actions will deplete the amount of enzymes within the body, which is used in digesting food. These live enzymes are essential for digestion and therefore the breakdown of the food consumed. If the food is not broken down properly, the food will not be able to be absorbed properly or completely by the body. Foods that are raw, living, whole foods like fresh, raw, whole, un-hulled, organic sesame seeds supply a portion of their own digestive enzymes. The live digestive enzymes from the food will aid the body in digestion, creating a healthier digestive system. The fiber of the whole food also helps with keeping the intestinal tract clean. When food is not broken down properly, the food will not be able to be absorbed properly or completely by the body. The body absorbs most of nutrients in the intestinal tract through the intestinal wall. A clean intestinal wall will help the nutrients be absorbed more easily (Addison, 2012).

When we are young, we have a natural abundance of enzymes. By the time we are elderly, we have lost over half of our enzymes. Our digestive system is only able to digest about half of the food we eat. An apple that has not been irradiated will have a ratio of about 40 to 60 enzymes. In other words, the apple will provide the live enzymes for breaking down for digestion about 40 to 60 percent of that apple, before our body has to produce the enzymes or acid to complete the digestion process. Cooked food and/or processed food, on the other hand, has no living enzymes therein to help the body digest the processed food. Therefore, the body is forced to use its precious supply of digestive enzymes in order to break down the food, in order to utilize any of the nutrients. This causes stress on the digestive system, the pancreas, and the immune system. When cooked foods are consumed, the body has to break down 100 percent of the cooked foods, creating a depletion of digestive enzymes. Decreased enzyme levels are found in a number of chronic ailments, such as allergies, skin disease and even serious diseases like diabetes and other severe diseases (Addison, 2012).

In a study, rats on a raw, living food diet lived about 50 percent longer than rats on cooked food. Raw food is a good source of food. The whole, organic, unprocessed ingredients in the healthful sea salt mixture are also more alkalizing. A diet high in whole, mineral rich food contributes to a more alkaline-rich diet, which can help with the maintenance of the pH in the body. Disease can thrive in an acidic environment, so maintaining the pH is important for health. A high level of acid is a byproduct of stress and the foods we consume. Apparently, the concept of balancing acid in the body has been established since the 1930s, when Dr. William Howard Hay published a book called A New Health Era in which he proclaimed that all disease was caused by an accumulation of acid in the body. A high level of acid waste in the body is the root cause of many illnesses. The body functions in a healthy range if the saliva stays between 6.5 and 7.5 all day. (Addison, 2012).

The pH balance of the body is critical to survival and health. It is as important as body temperature. The over-acidification of the body set in motion a destructive cycle of imbalance, overweight, and disease. A high level of acid in the body decreases oxygen in blood. Therefore, low levels of oxygen in blood disrupts metabolism. Consequently, the foods are digested more slowly inducing weight, sluggishness and food fermentation. Fermentation creates yeast, fungus, and mold throughout the body. These living organisms overgrow in the acidic environment and feed on the nutrients, reducing chemical and mechanical absorption of the digested foods by as much as 50 percent. Mild acidosis may cause problems such as cardiovascular damage, including the constriction of blood vessels and the reduction of oxygen; weight gain, obesity, and diabetes; bladder and kidney conditions, including kidney stones; immune deficiency; acceleration of free radical damage, possibly contributing to cancerous mutations; hormone concerns; premature aging, osteoporosis; joint pain, aching muscles and lactic acid buildup; low energy and chronic fatigue; and yeast and fungal overgrowth (Addison, 2012).

### The Importance Of Iodine:

The present invention does not only provide a whole food source of rich nutrients and minerals, but the present invention also serves as a substantial iodine supplementation. Iodine is an essential nutrient of the thyroid gland, which is our master gland. Iodine enables the thyroid gland to produce two key hormones: triodothyronine (T3) and thyroxine (T4). Therefore, the thyroid gland controls vital functions and organs such as metabolism, digestion, energy, body temperature, sleep, mental acuity, nervous system, hormone regulation, sexual organs, skin, and hair. Few systems in the body are not influenced by the thyroid gland. Because of the widespread effects of the thyroid gland, malfunction can significantly affect the life of a person and pose a detriment to long-term health. Severe iodine deficiency can cause brain disorders, goiters, hypothyroidism, and thyroid cancer. The average adult needs 150 micrograms of iodine per day, but our small thyroid gland can store up to 90 days' worth of iodine (Addison, 2012).

Iodine is an important element of alertness, rapid brain activity, and a prime deterrent to arterial plaque. Iodine is also a key factor in control and prevention of many endocrine deficiency conditions which are prevalent today. These endocrine deficiency conditions include breast and uterine fibroids, tumors, prostate inflammation, adrenal exhaustion, and toxic liver and kidney states (Page, 1994). Unfortunately, not all iodine is beneficial to humans and the human thyroid cannot distinguish between life sustaining iodine-127 and radioactive iodine-131. It is beneficial to consume high end iodine to insure a full body complement of iodine at all times as preventative medicine against the next nuclear disasters such as intentional radioactive pollution as the result of armed conflict or terrorism, nuclear power plant failures, or industrial contamination. A full body load of iodine-127 from seaweeds or any source will allow the body to reject iodine-131 from topical, air, and food sources. Iodine-131 is especially present in fresh milk (Drum, 2012).

In the event of a nuclear reactor accident, individuals affected by radioactive isotopes such as iodine-129 and iodine-131 will inevitably absorb radioactive iodine in their diet. If this radioactive iodine gets in the body, it will be concentrated in the thyroid gland, where it may damage cellular deoxyribonucleic acid (DNA). Long-term exposure of radioactive iodine increases the risk of thyroid cancer. There have been an increase in number of thyroid cancer cases among those who were exposed to radiation during the Chernobyl nuclear accident (Katz, 2011). Giving iodine tablets containing iodine-127 or potassium iodine to individuals who may be exposed in the area of a nuclear reactor accident lessens the risk of a person accumulating a large amount of radioactive iodine in his or her body. By administering a high dosage of iodine-127 compared to a lower amount needed, the radioactive iodine may be diluted by the excess iodine-127. In addition to diluting radioactive iodine, excess iodine-127 may cause the body to shut down iodine absorption for a period of days to weeks in order to prevent overload. This is known as the Wolff-Chaikoff effect. Therefore, administering iodine tablets lessens the increase in thyroid cancer risk that follows exposure after a nuclear reactor accident.

Until 1980, the iodine was added to bread at bakeries. Thereafter, the nutrient was replaced by potassium bromate (Addison, 2012). Once ingested, potassium bromate acts like iodine and will take up space. Consequently, potassium bromate will prevent the body from absorbing the iodine it needs. Chlorine and fluoride, which are found in water, act in the same manner as potassium bromate. Therefore, chlorine, fluoride, and potassium bromate can all contribute to iodine deficiency.

Due to its importance to the thyroid gland and essentially the entire human body, iodine is added to common table salt. Despite this artificial integration, however, iodine dissipates in the presence of oxygen. Therefore, common table salt is not a reliable source of iodine. Furthermore, common table salt is actually refined sodium with added chemicals such as bicarbonates, sugar, and preservatives (Addison, 2012). The natural minerals in unrefined sea salt are no longer present in the common table salt. Therefore, the body reads the common table salt as toxic chemicals. Unrefined sea salt, on the other hand, is full of minerals and nutrients essential to the human body. True sea salt is rich with electrolytes, which help the body absorb water and feed on a deep cellular level.

Currently, the soils are depleted of iodine; therefore, there are few foods that contain iodine (Addison, 2012). Therefore, iodine harvesters have turned to natural sources such as unrefined sea salt and sea vegetables. As illustrated in all the figures, unrefined sea salt and sea vegetables provide substantial amounts of natural and healthful iodine.

### The Importance Of Sea Salts:

In addition to harboring a variety of minerals, sea salt has been found to provide notable health benefits. Some benefits of ingesting crystal unrefined salt instead of refined white table salt include eliminating calcium deposits, increasing usable oxygen in blood, un-clumping red blood cells, detoxifying blood, balancing blood pressure, providing important nutrients for bones and enzymes, helping in building bone marrow, neutralizing radiation, making capillaries more elastic, increasing blood flow, adding extra electrons which eliminate radicals, balancing energy field, offering entire spectrum of electrolytes for the body, neutralizing uric acid and isolated sodium chloride, increasing elimination of heavy metals through the stools, and reducing sweet cravings (Hendel, 2003). Furthermore, of 100 men and women between the ages of 55 and 75 who had mild to moderate hypertension, when refined common table salt was replaced with mineral salt high in magnesium and potassium, a reduction in blood pressure occurred that was equivalent to blood pressure reducing drugs (Geleijnse, 1994).

Other vital functions of salt in the body include stabilizing irregular heartbeats, extracting excess acidity from brain cells, balancing sugar levels in the blood, generating hydroelectric energy in the cells, processing information between nerve cells, absorbing food particles through the intestinal tract, clearing the lungs of mucus and phlegm, clearing up catarrh and congested sinuses, preventing muscle cramps, preventing excess saliva production, firming bone structures, regulating sleep, stopping dry coughs, preventing gout and gouty arthritis, maintaining sexuality and libido, and preventing varicose veins and spider legs (Batmanghelidj, 1997).

Whole food salts have been known to enhance health in various ways through their balanced content of minerals and trace elements. Today with widespread mineral and trace element deficiencies; whole, unrefined sea salt is one of the most potent ways to attain more optimum health and well being. Crystal unrefined sea salt is by far the most beneficial of all whole food salts because crystal unrefined sea salt possesses a unique crystalline structure and the resulting life force enhancing effects Millions of years of extreme pressure and heat have transformed unrefined sea salt into a crystalline powerhouse of life energy whose benefits greatly exceed those of the highest quality unrefined sea salt. In a time of widespread mineral and life energy depletion, crystal unrefined sea salt is one of the most potent measures to attain radiant health and well being (Opitz).

When the human body perspires, the body loses many of the minerals that are in natural, unrefined, whole sea salt. Therefore, these minerals need to be replenished. Whole, unrefined sea salt can help balance the body by alkalizing the body or bringing a pH balance to the body (Addison, 2012). When a person experiences salt cravings, it is a sign that the person may be depleted in nutrients. Salt cravings can be a sign that the thyroid and adrenal glands are in need of minerals. It is recommended to use high-quality, mineral-rich, whole, unrefined sea salts instead of refined types of salt. If a person has been craving salt or experiencing high levels of stress, it is recommended the person have his or her thyroid checked for signs of iodine deficiency. Iodine may be scarce in many foods, but it is vital to our health.

There are different types of sea salt with different mineral content. It has been found that Celtic, Bolivian Rose and Pink Himalayan sea salts comprise high amounts of minerals. It is recommended to use a solar dried sea salt or a mined sea salt. Mined, sea salt is cleaner and denser because mined sea salt is from oceans that were less polluted and a more nutrient-dense time (Addison, 2012). Pink Himalayan sea salt is mined from the famous salt range within the Himalayan mountains using the traditional domed pillar method. The Bolivian rose sea salt is mined from ancient sea salt deposits in the Andes Mountain Range. The rose color comes from the minerals contained in the sea salt. The pink Himalayan sea salt has been processed over rare earth magnets, which rearrange and ensure proper sizing of the crystals within the pink Himalayan sea salt. Moreover, the pink Himalayan sea salt is colored sorted, which is an all-natural process that minimizes natural foreign material that is present in all natural sea salts. Furthermore, the pink Himalayan sea salt contains no anti-caking or free-flowing additives or conditioners. The pink Himalayan sea salt is intended for a variety of applications including gourmet and therapeutic spa applications. The pink Himalayan sea salt does not contain allergens or specific components, and is suitable for vegetarian, vegan, lactose intolerance, gluten intolerance diets. Furthermore, the pink Himalayan sea salt does not contain any melamine. The raw materials used are not of animal origin. The processing and packing material which is used during production repacking or filling of the salt does not make contact with meat products. The pink Himalayan sea salt does not contain any genetically modified organisms (GMO) and genetic engineering is not applied during the production process. GMO contamination is excluded during the treatment of the product. The pink Himalayan sea salt does not fall within the scope concerning the traceability and labeling of genetically modified organisms.

Both of the pink Himalayan sea salt and Bolivian rose sea salt have been, staph aureus, listeria, e. coli. Moreover, both of the pink Himalayan sea salt and Bolivian rose sea salt have been shipped and stored in polyethylene bags for added moisture protection. It has been recommended to store both of the pink Himalayan sea salt and Bolivian rose sea salt in a cool, dry place at humidity levels below 75 percent. Temperatures should be ambient. The shelf life for both the pink Himalayan sea salt and Bolivian rose sea salt is minimum four years after production date.

Unrefined sea salt is not only healthful to be added to foods, but also to drinking water as well. When accompanied by a small amount of unrefined sea salt, drinking water can treat chronic intracellular dehydration. An ounce of water should be consumed daily for every two pounds of body weight. Alternatively, a person whose body weight is 200 pounds should drink 100 ounces of water daily. This specified amount of water is in addition to other beverages. Water should be consumed firstly upon getting up in the morning and should be drunk continually, every two hours, on a daily basis. As for sea salt, ⅛ of teaspoon of sea salt on the tongue with every 16 ounces of water is recommended. The sea salt and water combination is important for people suffering from allergies or asthma because the salt also acts as an antihistamine (Batmanghelidj, 1997).

In addition to be added to water, salt may be added to other foods as well to help with the intake of certain nutrients. It is a good policy to add some salt to orange juice to balance the actions of sodium and potassium in maintaining the required volume of water inside and outside the cells. Salt is also added to melon and other fruits to accentuate the sweetness of the fruits. These fruits contain mostly potassium. Therefore, by adding salt to fruits before eating, a balance between intake of sodium and potassium results (Batmanghelidj, 1997).

Water is an important nutrient to our health and well-being. Our bodies are composed of 66 to 72 percent of water. Blood utilizes water to transport oxygen, nutrients, and antibodies to all parts of our body. Many illnesses are a result of dehydration. Drinking purified water without minerals will make the body pull minerals from the body itself in order to process the purified water. During the consumption of purified drinking water, minerals within the body will be lost. Therefore, a glass of high-quality, mineral-rich water is recommended upon waking up. When mineral-rich water is consumed, the body will not need to pull minerals from the body to process the water. Water filter systems such as the Reverse Osmosis provide clean drinking water, but the water is usually stripped of good minerals. Moreover, these water filter systems may in turn make the water very acidic. Adding whole, unprocessed sea salt or the sea salt mixture to the purified water will add the much needed minerals to the water as well as to help raise the pH balance of the water; so the water is healthier to consume (Addison, 2012).

### The Importance Of Sea Vegetables:

Sea vegetables (dulse flakes, sea lettuce flakes, and kelp) of the present invention were obtained from Maine Coast Sea Vegetables. Sea weed or sea vegetables provide all 56 minerals and trace elements required for the physiological functions of the body in quantities greatly exceeding those of land plants. Some notable examples are ⅓ cup serving of dulse or kelp gives up to 30 percent of Recommended Dietary Daily allowances (RDA), which is four times the iron in spinach, and more than kidney beans, apricots, and peas; the same size serving of alaria contains more calcium than ½ cup of boiled kale or bok-choy; magnesium is twice as abundant in kelp and alaria than in collard greens, and exceeds walnuts, bananas, oatmeal, and even sockeye salmon (Adams, 2011).

Sea vegetables present these essential nutrients to the body in a chelated, colloidal optimally balanced form so the nutrients are bio-available or readily absorbed and utilized by the body. Some of these major minerals include calcium, which is responsible for skeletal health, healthy heartbeat and nervous system function; magnesium, which activates enzymatic activity and is essential for healthy heartbeat; potassium, which prevents high blood pressure and provides cellular energy; sodium, which is essential for correct balance of body fluids or our internal “ocean;” iron, which as hemoglobin, transports and distributes oxygen to all cells in the body; chromium, which works with insulin to regular blood sugar; iodine, which is beneficial to thyroid health; copper, which protects nerve sheaths, builds supple arteries, and is required for iron absorption. The human body is composed of saline fluids which harbor the organs and cells. Once sea vegetables are consumed, sea vegetables bring balance to the internal environment within the human body with their high amounts of natural minerals, which serve as vital components (Adams, 2011).

Sea lettuce is the salad greens of sea vegetables. Sea lettuce is a leafy, vibrantly dark green sea vegetable with distinctive flavor and aroma. Sea lettuce is edible when consumed raw, but sea lettuce tends to have a slightly bitter taste when cooked. When other ingredients are added to cooked sea lettuce, the bitterness is thus subsided. Preferably, sea lettuce is a healthful ingredient to be integrated in soups and salads. Harvested and consumed worldwide, sea lettuce is abundant in temperate and colder seas. Sea lettuce obtained from Maine Coast Sea Vegetables is certified organic and has been tested for contaminants such as heavy metals, toxic chemicals and dangerous microbes. Nutritionally, the sea lettuce comprises high amounts of iron, protein, iodine, aluminum, manganese, and nickel. Therefore, the sea lettuce and dulse are nutritionally similar. Similar to most sea vegetables, sea lettuce provides considerable amounts of dietary fiber. Although sea vegetables are low temperature dried in the sun, the enzymes in the sea lettuce are still active (Adams, 2011).

Sodium is a major mineral that is essential to human health and life. Along with potassium, sodium provides electrolytic power that pumps nutrients in and out of cells. Sodium works with potassium to maintain the proper balance of fluids inside and outside of each cell. Our bodies have been evolutionarily designed to retain scarce and valuable sodium because sodium is not easily found in the environment. Potassium, however, has been plentiful in evolutionary diet which utilizes vegetables, nuts, seeds, and fruits. Therefore, humans do not retain potassium. Diet of modern humans has reversed the natural availability of sodium and potassium; potassium is removed from processed foods whereas sodium is used excessively as a flavor enhancer and preservative. In addition to lacking in magnesium and calcium, the imbalance of sodium and potassium is implicated in high blood pressure disease. Sodium as part of sodium chloride in unnatural, manufactured table salt is one of the main causes for high blood pressure disease (Adams, 2011).

As illustrated in Table 7, sea vegetables provide bio-available, essential sodium balanced with potassium as well as with calcium and magnesium at relatively low levels per serving. For example, dulse contains less sodium per serving than one slice of most commercial breads and one half to one third the sodium in one cup of cooked beet greens. Kelp contains ⅓ as much sodium, alaria ¼, dulse ⅛ and layer 1/9 as ½ teaspoon of table salt.

Sea weeds, once eaten regularly, are the best natural food sources of biomolecular dietary iodine, of which no land plants are reliable sources. For comparison, one would need to eat 40 pounds of fresh land vegetables and/or fruits in order to obtain as much iodine as one would from 1 gram of whole leaf kelp (Drum, 2012). As previously mentioned, iodine is the main component of the hormone produced by the thyroid gland, which regulates our metabolism. Specifically, thyroid hormone accelerates cellular reactions; increases oxygen consumption, basal metabolism; influences growth and development, energy metabolism, differentiation and protein synthesis (Drum, 2012).

Generally, brown sea vegetables such as kelps offer more bio-available organic iodine than red sea vegetables such as dulse, layer, and nori. Maine Coast Sea Vegetables offer two types of kelp. Whole leaf kelp, laminaria longicruris, has approximately 450 mcp or micrograms or parts per million iodine per gram. The milled kelp, laminaria digitata, sold in bulk in sea seasonings section, comprises even higher amounts, about 5000 mcg. In comparison, dulse contains about 150 mcg per gram. These amounts are approximations as there is variation depending on season of harvest and the age of plant. It is recommended to consume and intake iodine in moderation. Between 150 and 1,100 micrograms in the daily diets is the reputed range to keep the thyroid gland healthy and to prevent uptake of radioactive iodine. Healthy thyroids will discharge unneeded iodine if there is an excess of iodine (Adams, 2011).

As illustrated in Table 7, sea vegetables contain significant amounts of vitamins especially the B vitamins. A serving of dulse, which is 7 grams or ⅓ of a cup, provides about 10 percent RDA vitamin B2 or riboflavin, and about 42 percent RDA vitamin B6. Layer is rich in these B-vitamins and also contains 7 percent to 10 percent RDA vitamin A. Alaria offers even more vitamin A, which is up to 20 percent RDA, along with B vitamins. As illustrated in Table 7, vitamin B12 is present in many sea vegetables, through several different analytical methods. It has been disputed, however, whether vitamin B 12 present in sea vegetables is the actual mineral or simply an analogue. Sea vegetables are a rare vegetable source of vitamin B 12, which is produced by bacteria and usually found only in animals. Vitamin B 12 was probably made by bacteria living in surrounding seawater or on the surface of the plant. This speculation is supported by an important fact that various species of bacteria, or epiphytes, which use the surface of the sea plants as their substrate. Therefore, it is recommended to consume vitamin B 12 laden, low temperature dried, and minimally processed sea vegetables at the discretion of the consumer. The consumer may contact a health care practitioner about the consumption of vitamin B12 (Adams, 2011).

As illustrated in Table 7, the protein content of the sea vegetables ranges from 16 percent to 28 percent. The red sea vegetables, especially dulse and layer, are higher than the brown vegetables such as kelp and alaria. The amino acid composition of these sea vegetable proteins is well balanced. Furthermore, these sea vegetable proteins contain all or most of the essential amino acids, which are amino acids the human body cannot produce. Therefore, the sea vegetables provide higher quality proteins than grains and beans even though sea vegetables provide less quantity per serving. For example, a serving of dulse would yield approximately 1½ grams of high quality proteins. One of the important amino acids found especially in kelp is glutamic acid. The amino acid naturally enhances flavors and tenderizes high protein foods like beans while aiding in their digestion. Glumatic acid also improves mental and nervous system activity; provides energy; controls alcoholism, schizophrenia and sweet cravings (Adams, 2011).

Sea vegetables are also beneficial to individuals who desire to manage their weight. The sea vegetables in the preferred embodiment are substantially low in unsaturated fat, which is only 1 percent to 2 percent, but their high iodine content can stimulate the thyroid to increase metabolism and burn calories. Furthermore, the fiber of the sea vegetables aids digestion. The sea vegetables of the present invention have been tested for omega-6 and omega-3, which are essential fatty acids. While omega-6 and omega-3 are present in small amounts, omega-6 and omega-3 occur in a favorable ratio of between 1.5 and 2 to 1, which is within the optimal, recommended ratio of between 2 and 3 to 1. The optimal, recommended ratio has been suggested by the National Institute of Health (NIH) (Adams, 2011).

A high fiber diet has been considered to be important in preventing cancer. The fiber is any substance that remains essentially undigested through the digestion process. Moreover, the fiber enhances glucose metabolism, which is an important factor to consider amongst diabetics. The fiber found in land plants such as oats, apples, and land vegetables, is composed of cellulose, lignans, and pectin. Unlike land vegetables, sea vegetables comprise their own unique fiber with beneficial medicinal properties. For example, alginic acid in kelp has been shown to be an important detoxifier for radioactive isotopes and heavy metals. Dulse, kelp, alaria, layer, which are all present in table, have been tested and found to harbor 30 percent fiber, of which one half is soluble fiber and the other half insoluble fiber. For comparison, dulse comprises about 33 percent total fiber, which is as much as oat bran. Therefore, a small serving of sea vegetables perhaps yields a higher amount of high quality and special fiber compared to a large serving of oat bran (Adams, 2011).

The integration of calcium in one's diet is also important as calcium is necessary for maintaining bone strength as well as for muscles to move and for nerves to carry messages between the brain and other parts of the body. Calcium is used to help blood vessels move blood throughout the body and to help release hormones and enzymes that affect almost every function in the human body. The body will pull calcium from the bones in order to regulate the pH balance of the body. The acidity of meat can upset the pH balance of the body. Animal proteins can inhibit the absorption of calcium. Unprocessed vegetarian food is primarily very alkalizing and helps maintain a good pH balance (Addison, 2012).

Another important mineral is magnesium, which is necessary for hundreds of bodily functions. Magnesium deficiency has been linked to migraines, allergies, anxiety, asthma, attention deficit disorder, diabetes, calcification of soft tissue, muscle cramps, osteoporosis, fibromyalgia, hearing loss, menstrual cramps, insomnia, irritability, trembling, and twitching. Magnesium deficiency can cause increased levels of adrenaline, which can cause feelings of anxiety. It has been found that magnesium is extremely beneficial for children with acute asthma. Furthermore, magnesium helps in facilitating calcium absorption. Currently, there are 56 percent of Americans with inadequate intakes of magnesium from food based on estimated average requirements. According to the USDA Agriculture Research Service website, the diets of many people do not contain enough magnesium for good health and sleep. In 1997, the United States Food and Nutrition Board set the recommended dietary allowance (or daily intake) for magnesium at 320 milligrams for women and 420 milligrams for men between ages 51 and 70 (Addison, 2012).

According to the United States Department of Agriculture (USDA), not only iodine is depleted in soils, but other minerals are depleted as well. Over time, the mineral content in fruits has declined tremendously. For examples, the calcium content of one medium apple has decreased from 13.5 mg in 1914 to 7.0 mg in 1992; the phosphorus content of one medium apple has decreased from 45.2 mg in 1914 to 10.0 mg in 1963 to 7.0 mg in 1992; the iron content of one medium apple has decreased from 4.6 mg in 1914 to 0.3 mg in 1963 to 0.18 mg in 1992; the potassium content has decreased from 117.0 mg in 1914 to 110.0 mg in 1963 to 115.0 mg in 1992; the magnesium has decreased from 28.9 mg in 1914 to 8.0 mg in 1963 to 5.0 mg in 1992 (Lindlaar, 1997). It has also been shown that traditional diets contain more minerals than modern diets (USDA, 1997).

Furthermore, the sums of averages of calcium, magnesium and iron in selected land vegetables such as cabbage, lettuce, tomatoes and spinach has declined from 400 milligrams in 1914 to 60 milligrams in 1997 (USDA, 1997). Due to low mineral content in soils and land vegetables, diseases related to mineral deficiency have increased. For example, from 1980 to 1994, heart conditions related to chromium, copper, magnesium, potassium and selenium deficiencies have increased 19 percent; chronic bronchitis, which is due to copper, iodine, iron, magnesium selenium, and zinc deficiencies has increased 56 percent; asthma which is related to magnesium deficiency has increased 87 percent; tinnitus which is due to calcium, magnesium and zinc deficiencies has increased 25 percent; bone deformities which are linked to calcium, copper, fluoride and magnesium deficiencies have been have increased 47 percent (USDC, 1997).

In conclusion, the healthful sea salt mixture provides an abundant amount of whole, unrefined, mineral and nutrient rich food, which is beneficial to the diet in numerous ways. Iodine, magnesium, zinc, calcium, iron, potassium, protein are just some of the minerals present in this mixture. The healthful sea salt mixture further provides live enzymes, high pH levels as well as nutrients that can help in preventing many diseases. The ingredients described herewithin are of the highest possible quality.

Although the invention has been explained in relation to its preferred embodiment, it is to be understood that many other possible modifications and variations can be made without departing from the spirit and scope of the invention as hereinafter claimed.

What is claimed is:

1. A healthful sea salt mixture comprises,
an at least one whole sea salt;
an at least one organic whole sea vegetable;
an at least one whole raw sesame seed type;
optional chia seeds;
optional milk thistle;
the at least one whole sea salt comprises compounds selected from the group consisting of Bolivian sea salt, Celtic sea salt, and pink Himalayan sea salt;
the at least one organic whole sea vegetable comprises compounds selected from the group consisting of alaria, dulse, kelp, layer, and sea lettuce;
the at least one whole raw sesame seed type comprises compounds selected from the group consisting of various families of sesame seeds; and
the at least one whole sea salt and the at least one organic whole sea vegetable each contains iodine-127.

2. The healthful sea salt mixture as claimed in claim 1, wherein the Bolivian sea salt comprises,
comprising about 95.5% by composition of sodium chloride;
comprising about 0.700% by composition of calcium;
comprising about 0.645% by composition of potassium;
comprising about 0.303% by composition of iron;
comprising about 0.208% by composition of magnesium; and
comprising about <0.003% by composition of iodine.

3. The healthful sea salt mixture as claimed in claim 1, wherein the pink Himalayan sea salt comprises,
comprising about 60.050% by composition of chloride;
comprising about 39.000% by composition of sodium;
comprising about 0.346% by composition of sulfur;
comprising about 0.210% by composition of calcium;
comprising about 0.150% by composition of magnesium;
comprising about 0.100% by composition of potassium;
comprising about <0.003% by composition of iodine;
comprising about <1.080% by composition of nickel;
comprising about <0.250% by composition of lead;
comprising about <0.215% by composition of chromium;
comprising about <0.215% by composition of copper; and
comprising about <0.215% by composition of zinc.

4. The healthful sea salt mixture as claimed in claim 1, wherein the at least one organic whole sea vegetable comprises protein, carbohydrates, calories, fiber, calcium, potassium, magnesium, phosphorous, iron, sodium, iodine, manganese, copper, chromium, zinc, vitamin A, vitamin B1, vitamin B2, vitamin B3, vitamin B6, vitamin B12, vitamin C, vitamin E, omega-3, omega-6, and essential amino acids.

5. The healthful sea salt mixture as claimed in claim 1, wherein at least one whole raw sesame seed type contains sesamin, sesamolin, manganese, copper, magnesium, iron, phosphorous, vitamin B1, vitamin E, protein and fiber.

6. The healthful sea salt mixture as claimed in claim 1, wherein the chia seeds contain omega-3, dietary fiber and calcium.

7. The healthful sea salt mixture as claimed in claim 1, wherein the milk thistle contains silymarin.
